(19) United States
(12) Patent Application Publication
(10) Pub. No.: US 2026/0199979 A1
(43) Pub. Date: Jul. 16, 2026

(54) MANUFACTURING OF A PART MADE OF AN IRON-BASED ALLOY

(71) Applicants: ELECTRICITE DE FRANCE, PARIS (FR); INSTITUT NATIONAL DES SCIENCES APPLIQUEES DE LYON, VILLEURBANNE (FR); UNIVERSITE CLAUDE BERNARD LYON 1, VILLEURBANNE (FR); CENTRE NATIONAL DE LA RECHERCHE SCIENTIFIQUE, PARIS (FR)

(72) Inventors: Flore VILLARET, MORET SUR LOING (FR); Antoine KIEFFER, FONTAINEBLEAU (FR); Xavier BOULNAT, GENAY (FR); Michel PEREZ, MIRIBEL (FR)

(73) Assignees: ELECTRICITE DE FRANCE, PARIS (FR); INSTITUT NATIONAL DES SCIENCES APPLIQUEES DE LYON, VILLEURBANNE (FR); UNIVERSITE CLAUDE BERNARD LYON 1, VILLEURBANNE (FR); CENTRE NATIONAL DE LA RECHERCHE SCIENTIFIQUE, PARIS (FR)

(21) Appl. No.: 19/451,053

(22) Filed: Jan. 16, 2026

(30) Foreign Application Priority Data
Jan. 16, 2025 (FR) FR2500442

(51) Int. Cl. B22F 10/22; B22F 12/53; B33Y 10/00; C22C 33/04; C22C 38/02; C22C 38/04; C22C 38/08; C22C 38/12

(52) U.S. Cl. CPC B22F 10/22; B22F 12/53; B33Y 10/00; C22C 33/04; C22C 38/02; C22C 38/04; C22C 38/08; C22C 38/12

(57) ABSTRACT

A method for manufacturing a part made of an iron-based alloy is of submerged arc additive manufacturing type. The method allows the part to be obtained with required mechanical strength properties, particularly impact strength, directly after it is formed, with no need for a subsequent heat treatment at 500° C. or higher. The method is particularly well-suited for large parts, especially those intended for use in the construction of a nuclear power plant.

### TECHNICAL FIELD

This description relates to a method for manufacturing a part made of an iron-based alloy, and to a part that has been manufactured in this manner.

### BACKGROUND

Certain applications require parts made of an iron-based alloy that satisfy specific mechanical properties such as impact strength and/or tensile strength scores. These parts are commonly manufactured by casting and forging processes, and then undergo heat treatments to achieve the desired mechanical properties. Such heat treatments include annealing at at least 500° C. (degrees Celsius) to eliminate work hardening stresses from the forging stage, and/or quenching at at least 750° C.

This is the case for the manufacturing of parts for the nuclear sector, for example reactor vessel components or certain primary circuit components for nuclear power plants. Furthermore, some of these parts are very large, weighing tens of tons. These very large dimensions make it difficult to cast the alloy ingot, and they do not allow controlling the variations in cooling rate that arise during a post-forging heat treatment. As a result, these very large parts may exhibit inhomogeneities in their microstructure and in their mechanical properties, which can make it difficult to certify them for the required specifications.

For parts intended for nuclear power plants, the specifications are provided by the French RCC-M code (Règles de Conception et de Construction des matériels Mécaniques—Design and Construction Rules for Mechanical Components), which is publicly available.

### SUMMARY

Based on this situation, one object of the present invention is to provide a method for manufacturing parts that meet prescribed mechanical requirements, the proposed method being simpler, faster, and more economical than the one based on casting and forging.

Another object of the invention is to provide parts that meet mechanical requirements directly after they are formed, without the need for subsequent heat treatment.

Yet another object of the invention is to provide parts having large dimensions, such as those required for use in nuclear power plants, with reduced manufacturing times and costs.

To achieve at least one or more of these objects, a first aspect of the invention provides a method for manufacturing a part made of an iron-based alloy of the low-alloy type where the iron content in the alloy, expressed as a mass percentage, is greater than 95.0%. This method is a method of submerged arc additive manufacturing, wherein the part is progressively formed by depositing superimposed segments of the alloy. The alloy is supplied for each segment by at least two feed heads which deliver respective delivery wires. At the same time, these feed heads are conducting respective electric currents flowing from the delivery wire of each feed head to the part being manufactured, causing the alloy to melt between each delivery wire and the part being manufactured. The method also comprises supplying a quantity of flux. Such a method can be carried out continuously throughout the forming of the part.

According to a first feature of the method, the feed heads are arranged so that the alloy melting between each delivery wire and the part being manufactured forms a single melt pool shared by the delivery wires. Furthermore, a flux supply system is designed so that the flux is covering the melt pool.

According to a second feature of the method, the delivery wires are fed into the melt pool by the feed heads at respective alloy deposition rates of between 5 kg/h (kilograms per hour) and 25 kg/h per feed head, and with a heat flux produced by each electric current of between 4 MJ/kg (megajoules per kilogram) and 10 MJ/kg, again for each feed head. This heat flux is calculated as the ratio of the electrical power dissipated by the electric current of the feed head, to the alloy deposition rate relating to the same feed head. Thus, a part weighing several tens of tons can be manufactured in a few tens of days, in a manner that is compatible with an acceptable manufacturing cost.

According to the invention, these features of the method allow three impact test pieces, cut from the manufactured part after the part has cooled down to 25° C. and without the part or the impact test pieces being heated to above 500° C., to have break energies KV which are greater than or equal to 56 J (joules), when each impact test piece has a V-notch geometry in accordance with the standard NF EN ISO 148 (2017), and the impact test is carried out at −20° C. in accordance with the standard ISO 148-1 (2017) with a Charpy RKP450 impact tester, the three impact test pieces having, before being cut from the manufactured part, longitudinal directions which are respectively parallel to the segments forming the part, to a direction of superposition of these forming segments, and to a thickness direction of the part which is perpendicular to the forming segments and to the direction of superposition. Therefore, it is not necessary to reheat the part to higher 500° C., particularly to around 700° C., after it has been formed, in order to achieve the minimum impact strength of 56 J. This is especially advantageous for large or very large manufactured parts, for example from a few tens or hundreds of kilograms to several hundred tons, for which reheating is costly and the temperature distribution cannot be sufficiently controlled across the part. One explanation for directly obtaining sufficient impact strength in this manner is that the deposition of each alloy segment in the superposition that forms the part causes the underlying alloy segment to be heated to over 500° C., or even to over 750° C., providing it with its high impact strength. Thus, the forming process already incorporates a reheating that imparts the desired mechanical properties to the alloy part.

Advantages of the method of the invention are:
the required mechanical properties are obtained without a subsequent heat treatment, in particular without heat quenching or a so-called “high-quality” annealing treatment;
the manufactured part exhibits good homogeneity in its chemical composition;
the manufactured part exhibits good homogeneity and good isotropy for its mechanical properties; and
the mechanical properties are improved at an equivalent chemical composition, particularly the impact strength.

Additional advantages include:
the method allows for increased productivity in manufacturing the part;
the manufacturing time and cost of the part are reduced, in particular due to the absence of a subsequent heat treatment;
the method allows reducing the energy cost of manufacturing the part, particularly due to the absence of a subsequent heat treatment;
the manufacturing method, which is an additive manufacturing method, allows making certain local repairs to the part during manufacturing, to a greater extent than in casting and forging processes; and
for manufacturing parts that are large in size, a manufacturing device adapted to implement the method of the invention is less expensive than the devices required for casting and forging processes.

Preferably, the number of feed heads whose delivery wires share the melt pool may be two, three, four, or five. It is thus possible to adjust the part formation rate by adapting the number of feed heads.

Optionally, when three tensile test pieces are cut from the manufactured part after the part has cooled down to 25° C. and without the part or the tensile test pieces being heated above 500° C., these three tensile test pieces may exhibit elongations at break A that are greater than or equal to 20%, when each tensile test piece is in accordance with ISO 6892-1 (2019) with a cylindrical working portion that is 6 mm diameter, and where the tensile test is carried out at 25° C. with an ADAMEL 20/MH tensile testing machine in accordance with section 20 of ISO 6892-1 (2019), the three tensile test pieces having, before being cut from the manufactured part, longitudinal directions which are respectively parallel to the segments forming the part, to the direction of superposition of the forming segments, and to the thickness direction of the part.

In addition, it is possible that the three tensile test pieces may exhibit offset yield values Rp0.2%, for an elongation of 0.2%, of at least 275 MPa (megapascals), preferably greater than 450 MPa.

It is further possible that the three tensile test pieces may exhibit tensile strength values Rm of at least 470 MPa, preferably at least 550 MPa, at necking onset.

It is therefore also unnecessary for the part to be heated above 500° C., in particular to around 700° C., to meet these minimum values of elongation at break A, offset yield values Rp0.2% for an elongation of 0.2%, and tensile strength Rm at necking onset.

Optionally, the manufactured part may have carbon (C), silicon (Si), manganese (Mn), nickel (Ni), and molybdenum (Mo) contents that are less than 0.25%, 0.60%, 1.60%, 1.03%, and 0.62% respectively, expressed as mass percentages in the alloy. Such chemical composition properties are homogeneous in the manufactured part on a macroscopic scale, for example between measurement points that are 50 mm apart.

The method is particularly suitable for parts intended for a nuclear power plant, because the aforementioned properties of impact strength, tensile strength, and chemical composition are compatible with the requirements of that application. In particular, the manufactured part may be a component of a nuclear power plant reactor pressure vessel (RPV), in particular an RPV lower head, an RPV side wall, an RPV nozzle area, or an RPV upper head, or a nuclear power plant pressurizer side wall, or a component of a nuclear power plant steam generator, in particular a steam generator lower shell, a steam generator tube sheet, a steam generator side wall, or a steam generator upper shell, or a component of a pump, valve, or tap of a nuclear power plant primary, secondary, or tertiary circuit, in particular a pump volute or a main live steam valve housing.

Preferably, each delivery wire may have a composition of S3Ni1Mo according to ISO 14171-A (2016), and the flux may have a composition of SA FB 155 AC H5 according to ISO 14174 (2019). These chemical compositions for the delivery wires and for the flux make it possible to obtain the part with a chemical composition that meets the composition requirements imposed on nuclear power plant components, in particular for the types of components listed above.

Preferably, the diameter of each delivery wire may be between 3 mm and 8 mm.

Finally, a second aspect of the invention relates to a part made of an iron-based alloy of the low-alloy type in which the iron content in the alloy is greater than 95.0% by mass, this part having been manufactured according to a method in accordance with the first aspect of the invention. In particular, the part may be one of the components listed above for use in a nuclear power plant.

### BRIEF DESCRIPTION OF FIGURES

The features and advantages of the invention will become more apparent from the following detailed description of some examples of non-limiting embodiments, with reference to the accompanying figures, in which:

FIG. 1 shows some of the main elements of a system for manufacturing parts that is usable with this description;

FIG. 2 is a table summarizing the prescribed chemical composition requirements for nuclear power plant parts;

FIG. 3a is a perspective diagram of a nuclear power plant reactor with the associated primary circuit;

FIG. 3b is a diagram of part of the primary circuit and an associated secondary circuit for the nuclear power plant reactor of [FIG. 3a];

FIG. 4 groups several views of the geometric definition of an impact test piece;

FIG. 5 groups several views of the geometric definition of a tensile test piece; and

FIG. 6 is a table that summarizes prescribed mechanical requirements for nuclear power plant parts.

### DETAILED DESCRIPTION

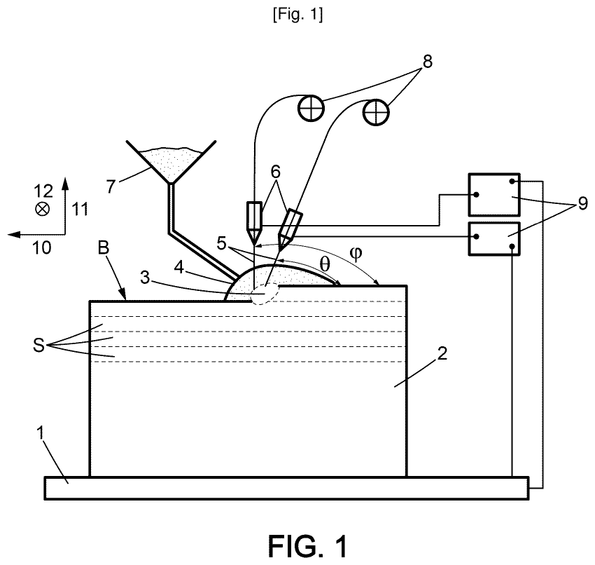

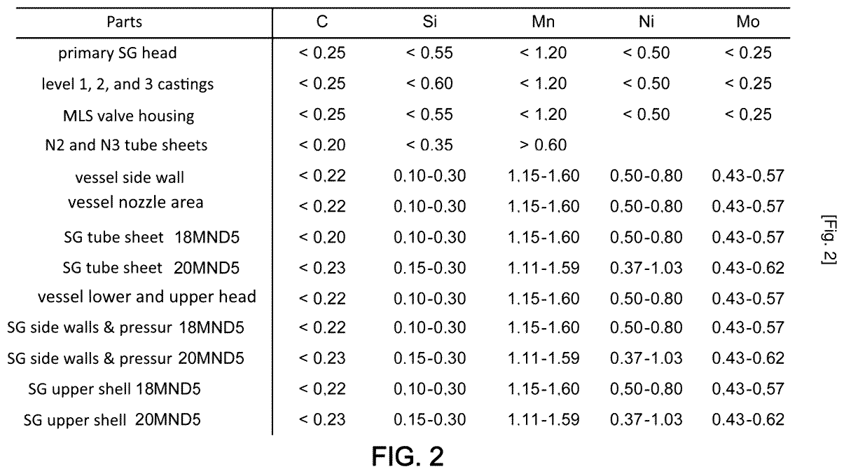

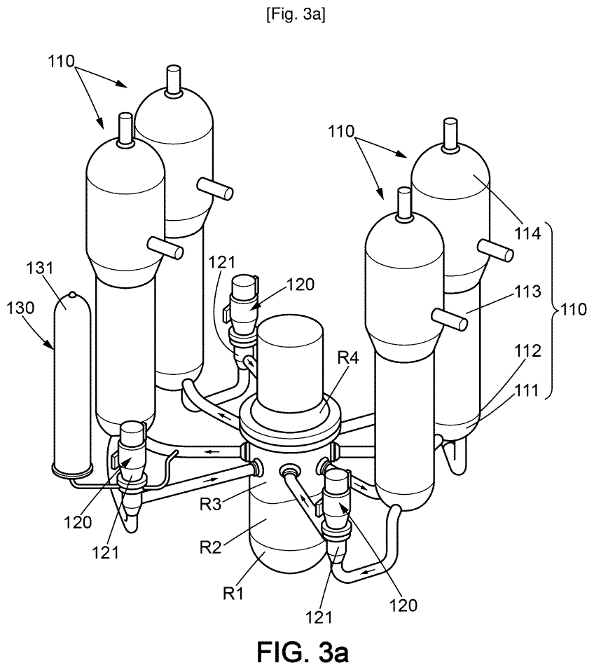

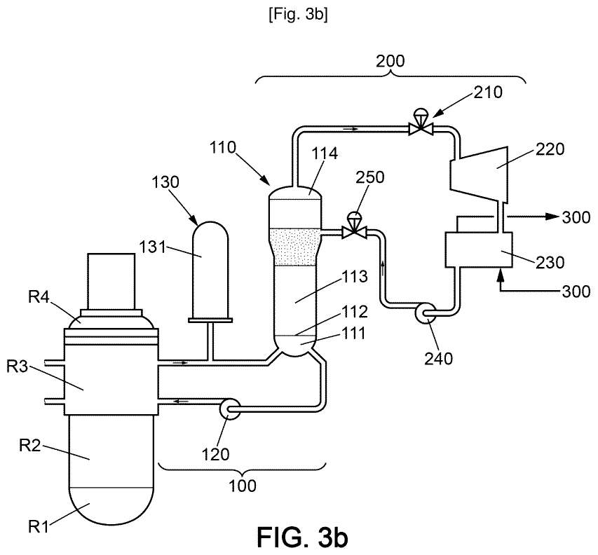

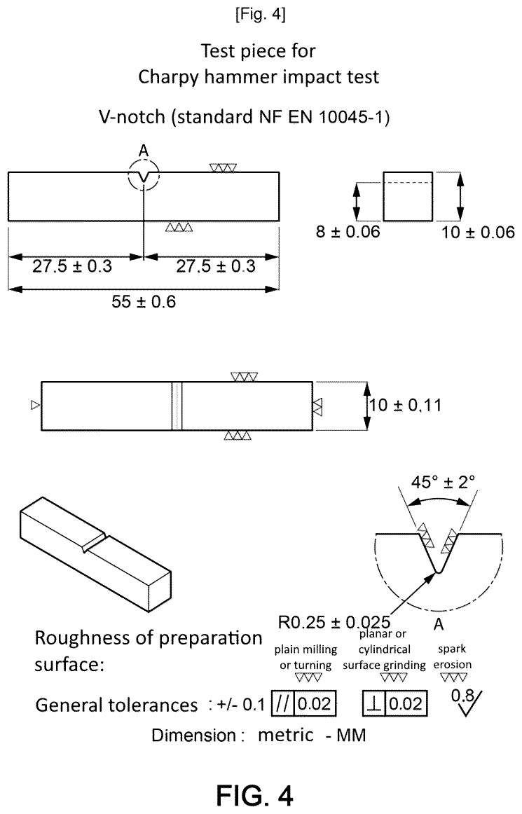

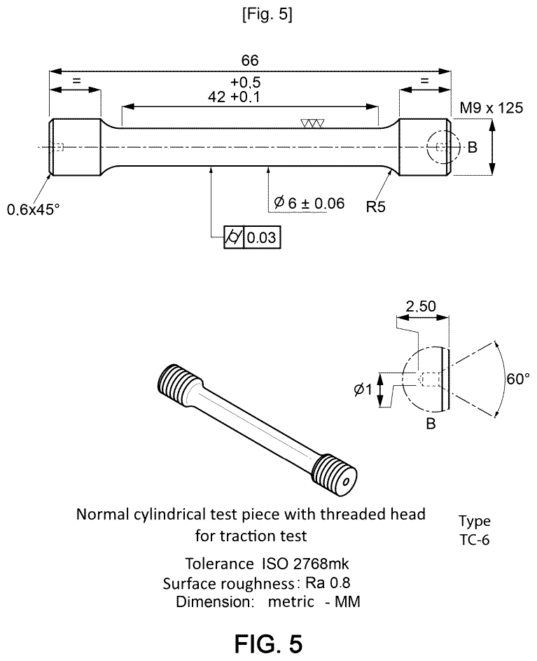

For clarity sake, the dimensions of the features shown in these figures do not correspond to actual dimensions nor to ratios of actual dimensions. In addition, some of these features are represented only symbolically in [FIG. 1], [FIG. 3a], and [FIG. 3b]. Furthermore, the content values for the chemical compositions in the table in [FIG. 2] are all expressed as mass percentages in the alloys, and the linear dimensions shown in [FIG. 4] and [FIG. 5] are all expressed in millimeters (mm).

In [FIG. 1], reference number 2 designates a part in the process of being manufactured from a low-alloy iron-based alloy. This part is held by a support 1, which is designed to present, oriented horizontally and upwards, an edge B of the part 2 where material is being added, substantially underneath the feed heads 6, for example two feed heads. The support 1 gradually moves the part 2 relative to the feed heads 6 so that the material supplied by the feed heads 6 is deposited in the form of segments S which are superimposed in the part 2. [FIG. 1] shows, in dashed lines, several superimposed alloy segments S. Each feed head 6 supplies a respective delivery wire 5 to the zone at the edge B of the part 2, where the material is transferred to the part 2 by solidification to continue forming the part. Each delivery wire 5 comes from a respective supply 8, for example, a spool or drum containing wire ready to be fed. Each delivery wire 5 is thus delivered to the forming zone of the part 2 at a linear feed rate that can be applied by the corresponding feed head 6. The method for manufacturing the part 2 is continuous over time, and during this manufacturing method, each delivery wire 5 constitutes a pathway for the flow of electric current between the corresponding feed head 6 and the part 2. An electric generator 9, associated with each feed head 6, supplies an electric current to the delivery wire 5 via this feed head, and this electric current is routed to the support 1. These electric currents, which may be direct or alternating, have the following two functions: firstly, to heat the delivery wires 5 between the feed heads 6 and the edge of the part 2, and secondly, to maintain a melt pool 3 on the edge of the part 2, under which a quantity of alloy is continuously solidifying, adding to the part 2. This continuous deposition of the alloy, as the part 2 is moved by the support 1, produces a segment of alloy S on the edge B of the part 2 in an additive manufacturing process, which continues the formation of the part 2. A flux supply system 7, comprising for example a hopper, a supply pipe, and a flux flow control device, is designed so that the flux forms a cover 4 over the melt pool 3. This cover 4 ensures that the melt pool 3 is not in contact with the air, thus preventing oxidation of the alloy, and concentrates some of the heat power produced by the electric currents via the Joule effect in order to keep the melt pool 3 in a liquid state. Preferably, the flux may be delivered as a solid powder by the supply system 7. The reference numbers 10, 11, and 12 respectively denote: the direction of the alloy segment S being deposited to form the part 2, oriented in the direction of advancement of the formation of the part 2; the direction of superposition of the alloy segments S in the part 2; and a thickness direction of the part 2 that is perpendicular to both preceding directions.

The feed heads 6 for the delivery wires 5 are arranged above the upper edge of the part 2 being manufactured and are each inclined so that the melt pool 3 is shared by the delivery wires 5; in other words, this melt pool 3 is a single, continuous pool extending between the respective entry points of all the delivery wires 5 that are in use simultaneously. Thus, all the delivery wires 5 contribute to forming a single alloy segment being deposited on the part 2 by solidification.

The following additional parameters may be used to implement the method of additive manufacturing, by way of non-limiting examples:
number of feed heads 6: two
material composition in the delivery wires 5: S3Ni1Mo according to ISO 14171-A (2016)
diameter of the delivery wires 5: 4 mm for example
angles of inclination 6 and (p of the delivery wires 5 relative to the edge of the part 2: each between 30° (degrees) and 150°
length of the delivery wires 5 between each feed head 6 and the melt pool 3: between 25 mm and 200 mm
intensity of the electric current injected into each delivery wire 5 by the corresponding feed head 6: between 100 A (amperes) and 1000 A
voltage delivered by each generator 9: between 25 V (volts) and 45 V
linear speed for feeding each delivery wire 5 in the corresponding feed head 6: between 800 mm/min (millimeters per minute) and 4400 mm/min
linear speed in advancing the melt pool 3 on the part 2 in direction 10: between 500 mm/min and 1500 mm/min
flux composition: S A FB 1 55 AC H5 according to ISO 14174 (2019)
flux feed rate: between 10 kg/h (kilograms per hour) and 75 kg/h

Under these conditions, Table 1 below lists the mass contents, denoted % mass and expressed as percentages relative to the total composition of the alloy, of the elements carbon (C), silicon (Si), manganese (Mn), nickel (Ni), and molybdenum (Mo), which were measured in the part 2 after its manufacture was completed according to the method just described:

TABLE 1

| Element | C | Si | Mn | Ni | Mo |
|---|---|---|---|---|---|
| % mass | <0.12% | 0.1%-0.3% | 0.8%-1.8% | <1.2% | 0.35%-0.65% |

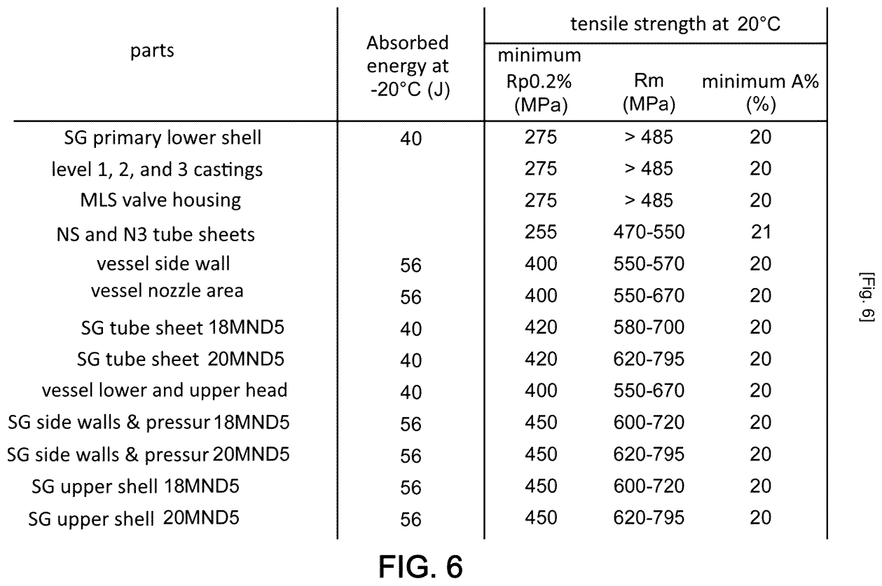

The table in [FIG. 2] lists requirements for the chemical composition as prescribed by the French RCC-M code and again expressed as mass percentages relative to the total composition of the alloy. As one can see, the mass contents measured for the part 2, which was manufactured according to the method described herein, are consistent with the requirements of many parts in the table in [FIG. 2]. In this table, as well as in that of [FIG. 6], the labels for the indicated parts have the following meanings for uses in a nuclear power plant, for example as illustrated by [FIG. 3a] and [FIG. 3b]:
“Primary SG head”: head 111 of the steam generator 110, on the primary circuit 100 side
“Level 1, -2, and -3 castings”: parts of the primary 100, secondary 200, and tertiary 300 circuits that are formed by casting in the prior art, in particular including valve bodies and pump volutes
“MLS valve housing”: main live steam valve housing 210, located between each steam generator 110 and the turbine 220 of the secondary circuit 200 “N2 and N3 tube sheets”: tube sheets of the heat exchangers of the secondary 200 and tertiary 300 circuits
“SG tube sheet 18MND5/20MND5”: tube sheet 112 of the steam generator 110 when made of alloy 18MND5 or 20MND5
“SG side walls and pressurizer 18MND5/20MND5”: side walls 113, 131 of the steam generator 110 and pressurizer 130 respectively, when made of alloy 18MND5 or 20MND5
“SG upper shell 18MND5/20MND5”: upper shell 114 of the steam generator 110 when made of alloy 18MND5 or 20MND5

These parts appear in [FIG. 3a] and [FIG. 3b] as described below. The references R1, R2, R3, and R4 respectively designate the reactor pressure vessel (RPV) lower head, the RPV side wall (also called a shell), the RPV nozzle area, and the RPV upper head of the nuclear reactor. As is known, the RPV nozzle area R3 supports tubes that transfer the heat produced by the reactor to the primary circuit 100, generating the main live steam (MLS). Several loops, four in the example shown, of the cooling primary circuit 100 of the reactor enter and exit the RPV nozzle area R3, each loop comprising a steam generator 110 and a pump 120. Each steam generator 110 comprises a steam generator lower shell 111, a steam generator tube sheet 112, a steam generator side wall 113, and a steam generator upper shell 114. Reference numeral 121 designates the volute of each pump 120. In addition, the primary circuit 100 comprises a pressurizer 130, which has a pressurizer side wall 131. As shown in [FIG. 3b], each secondary circuit 200 comprises main live steam (MLS) valves and taps 210, a turbine 220, a condenser 230, a pump 240, and a control valve 250 located before the return of the liquid to the steam generator 110 associated with this secondary circuit 200. The heat exchanger tube sheet, which is between the secondary circuit 200 and the tertiary circuit 300, is contained within the condenser 230.

Two mechanical strength tests were performed on the part 2 after it had been formed using the method for additive manufacturing described above, and without being heated to more than 500° C. after its formation. These two mechanical strength tests are an impact test and a tensile strength test.

The impact test was performed on three sets of three test pieces cut from the part 2 and then machined to obtain the geometric characteristics shown in [FIG. 4]. Each impact test piece thus has an elongate parallelepiped shape of 10×10×55 mm³, with a triangular notch having a 45° angular opening that is 2 mm deep at the center of one of its sides, and having a radius of curvature at the bottom of the notch of 0.25 mm. Such a test piece design is of the V-notch type in accordance with standard NF EN ISO 148 (2017). The test pieces are cut from the part 2 so that their respective longitudinal directions correspond to direction 10 for the first set of impact test pieces, direction 11 for the second set, and direction 12 for the third set. The three pieces of a same set are successively tested for impact strength in accordance with ISO 148-1 (2017) using a Charpy impact hammer RKP450 at a temperature of −20° C. Specifically, the hammer strikes each test piece on the side opposite the notch, with an energy of 450 J and a striking edge that is 2 mm thick. The property provided by such an impact test is the energy, denoted KV and expressed in joules, absorbed by the breaking of each test piece under the impact of the hammer's striking edge. An average value of the absorbed energy is calculated separately for each set of test pieces corresponding to one of the directions 10, 11, and 12.

The tensile strength test was performed on three pairs of other test pieces also cut from the part 2 but subsequently machined to obtain the geometric characteristics shown in [FIG. 5]. Each tensile test piece has an elongate shape with a central cylindrical working portion measuring 6 mm in diameter and 42 mm in length, and which extends at its two opposite ends into threaded heads with intermediate fillets at a 5 mm radius of curvature. This test piece design is in accordance with ISO 6892-1 (2019). These test pieces are also cut from the part 2 so that their respective longitudinal directions correspond to direction 10 for the first pair of tensile strength test pieces, direction 11 for the second pair, and direction 12 for the third pair. The two test pieces in each pair are successively tested for tensile strength at ambient temperature, typically 20° C., using an ADAMEL 20/MH tensile testing machine in accordance with section 20 of ISO 6892-1 (2019). The test control method is A2 as defined in that standard: the strain rate of the test piece is controlled by crosshead separation speed, corresponding to an elongation rate of 0.0002 s⁻¹ (relative elongation per second) produced by a crosshead separation speed of 0.6 mm/min (millimeters per minute) in order to determine the stress-strain for 0.2% elongation (offset yield), denoted Rp0.2%, as well as the tensile strength at necking onset, denoted Rm. The elongation at break, denoted A and expressed as a percentage, was measured after the test piece broke in accordance with section 20 of the same standard. The values of Rp0.2%, Rm, and A are then calculated as average values, separately for each pair of test pieces that are tension-tested. Finally, the extensometer used to monitor each tensile strength test is of the LVDT type, for “Linear Variable Differential Transformer”.

Table 2 below summarizes the results of these two mechanical strength tests. For each test, no significant difference was observed between the directions in which the test pieces were cut relative to the part 2, and the values shown are the averages calculated over the three sets or pairs of test pieces in each test:

TABLE 2

| Test of | Absorbed energy | Tensile strength at 20° C. | | |
|---|---|---|---|---|
| mechanical | at −20° C. | (average values) | | |
| strength | (average values) | Rp0.2% | Rm | A % |
| Value | 174 J | 601 MPa | 700 MPa | 23.5% |

The table in [FIG. 6] reproduces the mechanical strength requirements as prescribed by the French RCC-M code. As can be seen, the results of the impact and tensile strength tests obtained for the part 2, which was manufactured according to the method described herein, are consistent with the requirements for many parts in the table in [FIG. 6].

It is understood that the manufacturing method described may be reproduced while modifying some of its minor aspects but retaining at least some of the advantages mentioned. In particular, the delivery wires may be preheated upstream of the feed heads, independently of any heating dedicated to maintaining the melt pool in a liquid state. Specifically, the delivery wires may alternatively be preheated by induction or by injecting electric currents, and other electric currents may simultaneously be dedicated to supplying heat to the melt pool. Furthermore, each electrical current used to provide preheating power to one of the delivery wires and/or to maintain the melt pool in a liquid state may be either direct or alternating current, taking into account any applicable electrical safety requirements. Finally, all numerical values cited without being explicitly stated as necessary are provided for illustrative purposes only and can be adjusted according to each specific implementation.

1. A method for manufacturing a part made of an iron-based alloy of low-alloy type, where iron content in the alloy is greater than 95.0% by mass,
the method being of submerged arc additive manufacturing type, wherein the part is progressively formed by depositing superimposed segments of the alloy, the alloy being supplied for each segment by at least two feed heads which deliver respective delivery wires at a same time as said feed heads are conducting respective electric currents flowing from the delivery wire of each feed head to the part being manufactured, causing the alloy to melt between each delivery wire and said part being manufactured, the method further comprising supplying a quantity of flux,
wherein the feed heads are arranged so that the alloy melting between each delivery wire and the part being manufactured forms a single melt pool shared by the delivery wires, and wherein a flux supply system is designed so that said flux is covering the melt pool,
wherein the delivery wires are fed into the melt pool by the feed heads at respective alloy deposition rates of between 5 kg/h and 25 kg/h per feed head, and with a heat flux produced by each electric current of between 4 MJ/kg and 10 MJ/kg for each feed head, calculated as the ratio of an electrical power dissipated by the electric current of said feed head, to the alloy deposition rate relating to the same feed head,
so that, when three impact test pieces are cut from the manufactured part, after said part has cooled down to 25° C. and without the part or the impact test pieces being heated to above 500° C., the three impact test pieces exhibit break energies KV which are greater than or equal to 56 J, when each impact test piece has a V-notch geometry in accordance with standard NF EN ISO 148 (2017), and the impact test is carried out at −20° C. in accordance with standard ISO 148-1 (2017) with a Charpy RKP450 impact tester, the three impact test pieces having, before being cut from the manufactured part, longitudinal directions which are respectively parallel to the segments forming the part, to a direction of superposition of said forming segments, and to a thickness direction of the part which is perpendicular to said forming segments and to the direction of superposition.

2. The method according to claim 1, wherein a number of feed heads whose delivery wires share the melt pool is two, three, four, or five.

3. The method according to claim 1, wherein three tensile test pieces are cut from the manufactured part after the part has cooled down to 25° C. and without the part or the tensile test pieces being heated to above 500° C., the three tensile test pieces exhibiting elongations at break A that are greater than or equal to 20%, when each tensile test piece is in accordance with ISO 6892-1 (2019) with a cylindrical working portion that is 6 mm in diameter, and the tensile test is carried out at 25° C. with an ADAMEL 20/MH tensile testing machine in accordance with Section 20 of ISO 6892-1 (2019), the three tensile test pieces having, before being cut from the manufactured part, longitudinal directions which are respectively parallel to the segments forming the part, to the direction of superposition of the forming segments, and to the thickness direction of the part.

4. The method according to claim 3, wherein the three tensile test pieces exhibit offset yield values Rp0.2%, for an elongation of 0.2%, of at least 275 MPa, preferably greater than 450 MPa.

5. The method according to claim 3, wherein the three tensile test pieces exhibit tensile strength values Rm of at least 470 MPa, preferably at least 550 MPa, at necking onset.

6. The method according to claim 1, wherein the manufactured part has carbon, silicon, manganese, nickel, and molybdenum contents that are less than 0.25%, 0.60%, 1.60%, 1.03%, and 0.62% respectively, expressed as mass percentages in the alloy.

7. The method according to claim 1, wherein the manufactured part is a nuclear power plant reactor pressure vessel (RPV) component, in particular an RPV lower head, an RPV side wall, an RPV nozzle area, or an RPV upper head, or a nuclear power plant pressurizer side wall, or a component of a nuclear power plant steam generator, in particular a steam generator lower shell, a steam generator tube sheet, a steam generator side wall, or a steam generator upper shell, or a component of a pump, valve, or tap of a nuclear power plant primary, secondary, or tertiary circuit, in particular a pump volute or a main live steam valve housing.

8. The method according to claim 1, wherein each delivery wire has a composition of S3Ni1Mo according to ISO 14171-A (2016), and the flux has a composition of SA FB 155 AC H5 according to ISO 14174 (2019).

9. The method according to claim 1, wherein the diameter of each delivery wire is between 3 mm and 8 mm.

10. A part made of an iron-based alloy of low-alloy type in which iron content in the alloy is greater than 95.0% by mass, this part having been manufactured according to claim 1.
